(19) United States
(12) Patent Application Publication
(10) Pub. No.: US 2024/0228323 A9
(43) Pub. Date: Jul. 11, 2024

(54) PROCESS FOR MAKING A PARTICULATE (OXY)HYDROXIDE OR OXIDE

(71) Applicant: BASF SE, Ludwigshafen am Rhein (DE)

(72) Inventors: Thorsten BEIERLING, Ludwigshafen (DE); Rafael Benjamin BERK, Ludwigshafen (DE); Lukas Karl METZGER, Ludwigshafen (DE)

(21) Appl. No.: 18/548,011

(22) PCT Filed: Mar. 4, 2022
(86) PCT No.: PCT/EP22/55639

§ 371 Date: Aug. 25, 2023

(30) Foreign Application Priority Data
Mar. 10, 2021 (EP) 21161886.3

(51) Int. Cl. C01G 53/00

(52) U.S. Cl. CPC C01G 53/42; C01P 2004/03; C01P 2006/12; C01P 2006/82

(57) ABSTRACT

Disclosed herein is a process for making a particulate (oxy)hydroxide, carbonate, or oxide of TM which includes nickel and at least one metal selected from the group consisting of cobalt, manganese, and aluminum. The process includes providing an aqueous solution (α1) containing a water-soluble salt of Ni, one of an aqueous solution (α2) containing a water-soluble salt of Co, an aqueous solution (α3) containing a water-soluble salt of Mn, or an aqueous solution (α4) containing a water-soluble compound of Al, an aqueous solution (β) containing an alkali metal hydroxide or carbonate and, optionally, an aqueous solution (γ) containing ammonia or an organic acid or its alkali metal salt, combining solution (α1) and solution (β) and at least one of solutions (α2), (α3), (α4), and, if applicable, solution (γ), in different locations of a continuous reactor, and removing the particles from the liquid by a solid-liquid separation method.

The present invention is directed towards a process for making a particulate (oxy)hydroxide or carbonate or oxide of TM wherein TM comprises nickel and at least one metal selected from cobalt and manganese and aluminum wherein said process comprises the steps of:
(a) Providing an aqueous solution (α1) containing a water-soluble salt of Ni and an aqueous solution (α2) containing a water-soluble salt of Co or an aqueous solution (α3) containing a water-soluble salt of Mn or an aqueous solution (α4) containing a water-soluble compound of Al, and an aqueous solution (β) containing an alkali metal hydroxide or carbonate and, optionally, an aqueous solution (γ) containing ammonia or an organic acid or its alkali metal salt,
(b) combining solution (α1) and solution (β) and at least one of solutions (α2) or (α3) or (α4), and, if applicable, solution (γ), in a continuous reactor, thereby creating solid particles of a hydroxide or carbonate of TM, wherein such solutions are introduced into said continuous reactor in different locations,
(c) separating the particles from step (b) from the liquid phase by a solid-liquid separation method.

Lithiated transition metal oxides are currently being used as electrode active materials for lithium-ion batteries. Extensive research and developmental work have been performed in the past years to improve properties like charge density, specific energy, but also other properties like the reduced cycle life and capacity loss that may adversely affect the lifetime or applicability of a lithium-ion battery. Additional effort has been made to improve manufacturing methods.

In a typical process for making cathode materials for lithium-ion batteries, first a so-called precursor is being formed by co-precipitating the transition metals as carbonates, oxides or preferably as hydroxides that may or may not be basic, for example oxyhydroxides. The precursor is then mixed with a source of lithium such as, but not limited to LiOH, Li₂O or Li₂CO₃ and calcined (fired) at high temperatures. Lithium salt(s) can be employed as hydrate(s) or in dehydrated form. The calcination—or firing—often also referred to as thermal treatment or heat treatment of the precursor—is usually carried out at temperatures in the range of from 600 to 1000° C. During the thermal treatment a solid-state reaction takes place, and the electrode active material is formed. The thermal treatment is performed in the heating zone of an oven or kiln.

A typical class of cathode active materials delivering high energy density contains a high amount of Ni (Ni-rich), for example at least 80 mol-%, referring to the content of non-lithium metals. The performance of the cathode active materials (“CAM”) such as capacity and especially cycle life is strongly affected by the interaction between the CAM and the electrolyte in the respective electrochemical cell. Here, specially Ni tends to be very reactive leading to the formation of side products that decrease the capacity of the battery during cycling. To overcome this, it is suggested to coat CAM with compounds of aluminum or cobalt that suppresses to a large extend the unwanted side reaction in the electrochemical cell. Such coating is usually done a separate post-treatment step after the calcination. Such a process step is expensive and increases the specific production costs of a CAM significantly.

To a major extent, properties of the precursor translate into properties of the respective electrode active material to a certain extent, such as particle size distribution, content of the respective transition metals and more. It is therefore possible to influence the properties of electrode active materials by steering the properties of the precursor.

It is an objective of the present invention to provide a process that is very flexible and allows to use a simple and versatile equipment to make a broad variety of precursors. It is particular an objective to provide a continuous process that is very flexible and allows to use a simple and versatile equipment for making precursors that show a gradient or coating or the like of the elements in the particles. It was further an objective of the present invention to provide a precursor for an electrode active material that wherein such precursor can be made easily and shows a gradient or coating.

Accordingly, the process as defined at the outset has been found, hereinafter also defined as “inventive process” or “process according to the (present) invention”.

The inventive process is a process for making a particulate (oxy)hydroxide or oxide or carbonate of TM. Said particulate (oxy)hydroxide or oxide or carbonate then serves as a precursor for electrode active materials, and it may therefore also be referred to as precursor.

In one embodiment of the present invention, the resultant precursor is comprised of secondary particles that are agglomerates of primary particles.

In one embodiment of the present invention the specific surface (BET) of the resultant precursor is in the range of from 2 to 70 m²/g, determined by nitrogen adsorption, for example in accordance with to DIN-ISO 9277:2003-05. The outgassing temperature is 120° C.

The precursor is an (oxy)hydroxide of TM wherein TM comprises Ni and at least one metal selected from Co and Mn and Al, and, optionally, at least one further metal selected from Ti, Zr, Mo, W, Mg, and Nb.

In one embodiment of the present invention, TM is a combination of metals according to general formula (I)

(NiₐCo_{b}Mn_{c})_{1-d}M_{d} (I)
with
a being in the range of from 0.5 to 0.95, preferably from 0.8 to 0.92,
b being zero or in the range of from 0.025 to 0.5, preferably from 0.025 to 0.15,
c being in the range of from zero to 0.2, preferably from zero to 0.15, and
d being in the range of from zero to 0.1, preferably from zero to 0.05,
M is selected from Mg, Al, Ti, Zr, Mo, W, and Nb,
a+b+c=1, and b+c>zero or M includes Al and d>zero.

TM may contain traces of further metal ions, for example traces of ubiquitous metals such as sodium, iron, calcium or zinc, as impurities but such traces will not be taken into account in the description of the present invention. Traces in this context will mean amounts of 0.05 mol-% or less, referring to the total metal content of TM.

The precursors are particulate materials. In one embodiment of the present invention, precursors have an average particle diameter D50 in the range of from 3 to 20 μm, preferably from 4 to 16 μm. The average particle diameter may be determined, e. g., by light scattering or LASER diffraction or electroacoustic spectroscopy. The particles are composed of primary particles, in particular they are agglomerates of primary particles, and the above particle diameter refers to the secondary particle diameter.

In one embodiment of the present invention, the span of the particle diameter distribution of the precursor is in the range of from 0.9 to 2.0. The span is defined as [(D90)−(D10)]/(D50), with the values of (D90), (D50) and (D10) being determined by dynamic light scattering.

Said particulate material may have an irregular shape but in a preferred embodiment, said particulate material has a regular shape, for example spheroidal or even spherical. The aspect ratio may be in the range of from 1 and 10, preferably from 1 to 3 and even more preferably from 1 to 1.5. The aspect ratio is defined as the ratio of width to length or specifically the particle diameter in the longest dimension versus the particle diameter in the shortest dimension. Perfectly spherical particles have an aspect ratio of 1.

The inventive process comprises at least three steps, hereinafter also referred to as step (a), step (b) and step (c), respectively, and may include further—optional—steps. Steps (a) to (c) are described in more detail below.

Step (a) includes providing
an aqueous solution (α1) containing a water-soluble salts of Ni and
an aqueous solution (α2) containing a water-soluble salt of Co
or an aqueous solution (α3) containing a water-soluble salt of Mn
or an aqueous solution (α3) containing a water-soluble compound of Al,
and an aqueous solution (β) containing an alkali metal hydroxide or carbonate
and, optionally, an aqueous solution (γ) containing ammonia or an organic acid or its alkali metal salt. Said aqueous solutions will be referred to as solutions in brief.

The term water-soluble salts of cobalt and nickel or manganese or of metals other than nickel and cobalt and manganese refers to salts that exhibit a solubility in distilled water at 25° C. of 25 g/l or more, the amount of salt being determined under omission of crystal water and of water stemming from aquo complexes. Water-soluble salts of nickel and cobalt and manganese may preferably be the respective water-soluble salts of Ni²⁺ and Co²⁺ and Mn²⁺. Examples of water-soluble salts of nickel and cobalt are the sulfates, the nitrates, the acetates and the halides, especially chlorides. Preferred are nitrates and sulfates, of which the sulfates are more preferred.

The term “water-soluble compounds of aluminum” then refers to compounds like Al₂(SO₄)₃, Al(NO₃)₃, KAl(SO₄)₂, NaAlO₂ and NaAl(OH)₄. Depending on the choice of water-soluble compound of aluminum, the pH value of aqueous solution (α4) may be in the range of from 1 to 3 or above 13.

Solution (α1) may have a pH value in the range of from 2 to 5. In embodiments wherein higher pH values are desired, ammonia may be added to solution (α1). However, it is preferred to not add ammonia to solution (α). Solutions (α2) and (α3) may have a pH value in the range of from 2 to 5 as well.

In one embodiment of the present invention, the concentration of nickel in solution (α1) and of cobalt in solution (α2) or of manganese in solution (α3) or of aluminum in solution (α4), as the case may be, can be selected within wide ranges. Preferably, the respective metal concentration is selected to be within a range of 1 to 1.8 mol of the metal/kg of solution, more preferably 1.5 to 1.7 mol of the metal/kg of solution.

In step (a), in addition an aqueous solution of alkali metal hydroxide or carbonate is provided, hereinafter also referred to as solution (β). An example of alkali metal hydroxides is lithium hydroxide, preferred is potassium hydroxide and a combination of sodium and potassium hydroxide, and even more preferred is sodium hydroxide. Examples of alkali metal carbonates are sodium carbonate and potassium carbonate, with preference to be given to sodium carbonate.

In one embodiment of the present invention, solution (β) contains mainly alkali metal hydroxide and some amount of carbonate, e.g., 0.1 to 2% by weight, referring to the respective amount of alkali metal hydroxide, added deliberately or by aging of the solution or the respective alkali metal hydroxide.

Solution (β) may have a concentration of hydroxide in the range from 0.1 to 12 mol/l, preferably 6 to 10 mol/l.

The pH value of solution (β) is preferably 11.5 or higher, in embodiments with alkali metal hydroxides the pH value is preferably 13 or higher, for example 14.5.

In the inventive process, it is preferred to use ammonia but to feed it separately as solution (γ) or in solution (β) but not in solution (α).

In step (a), optionally an aqueous solution (γ) may be provided that contains ammonia or a carboxylic acid, preferably a carboxylic acid with a low volatility. A low volatility in this context refers to a boiling point or decomposition temperature of more than 200° C. at normal pressure. Examples are amino acids such as glycine and dicarboxylic acids such as tartaric acid and tricarboxylic acids such as citric acid or, in each case, the respective alkali metal salts. The concentration may be in the range of from 1 to 150 g of the respective carboxylic acid, calculated without alkali metal counterions. In embodiments wherein solution (γ) contains ammonia the concentration of ammonia may be in the range of from 10 to 250 g/l.

In step (a), optionally an aqueous solution (δ) may be provided that contains at least one water-soluble compound of a metal M selected from Mg, Ti, Zr, Mo, W, And Nb.

Examples of suitable compounds of Mg are MgSO₄, Mg(NO₃)₂, magnesium acetate and MgCl₂, with MgSO₄ being preferred.

Examples of suitable compounds of Ti are Ti(SO₄)₂, TiOSO₄, TiO(NO₃)₂, Ti(NO₃)₄, with Ti(SO₄)₂ being preferred.

Examples of suitable compounds of Zr are zirconium acetate, Zr(SO₄)₂, ZrOSO₄, ZrO(NO₃)₂, Zr(NO₃)₄, with Zr(SO₄)₂ being preferred.

Examples of suitable compounds of Nb are (NH₄)Nb(C₂O₄)₃ and (NH₄)NbO(C₂O₄)₂. Examples of suitable compounds of Mo are MoO₃, Na₂MoO₄, and (NH₄)₂MoO₄.

Examples of suitable compounds of W are WO₃, WO₃·H₂O, Na₂WO₄, ammonium tungstate and tungstic acid.

Step (b) includes combining solution (α1) and solution (β) and at least one of solutions (α2) or (α3) or (α4), and, if applicable, solution (γ), in a continuous reactor, thereby creating solid particles of a hydroxide or carbonate of TM, wherein such solutions are introduced into the continuous reactor in different locations.

Examples of continuous reactors are plug flow reactors and in particular continuous stirred tank reactors. Continuous reactors have an outlet where reaction mixture is withdrawn from the reactor, namely the precursor that is slurried in mother liquor. In case of continuous stirred tank reactors, an overflow is a preferred embodiment of an outlet.

In one embodiment, the pH value in step (b) is in the range of from 10 to 14. In another embodiment, especially when carbonates are made according to the inventive process, the pH value in step (b) is in the range of from 7 to 9.

That means, in step (b), solution (α1) is combined with solution (β) and with at least one of solutions (α2) or (α3) or (α4), and, if applicable, with any of solutions (γ) or (δ) in reactor. Said combination takes place in the reactor, and it is performed in a way the solution (α1) and at least one of solutions (α2) or (α3) or (α4), and, if applicable, solution (γ), are introduced into the reactor in different locations. In such embodiments, it is preferred that solution (α1) and solution (β) and at least one of solutions (α2) or (α3) or (α4), and, if applicable, any of solutions (γ) or (δ) are introduced through different inlets.

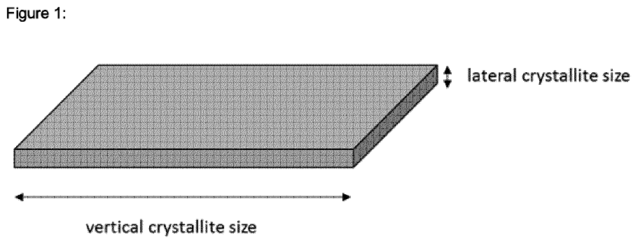

In one embodiment of the present invention, step (b) is performed in a continuous stirred tank reactor. In such embodiments, it is preferred that solution (α1) and at least one of solutions (α2) or (α3) or (α4), and, if applicable, any of solutions (γ) or (δ) are introduced through different inlets, for example through different nozzles. Such inlets may be attached at the lid of the stirred tank reactor. It is preferred, then, that the inlets are arranged in a circuit around the stirrer, see FIG. 1.

In one embodiment of the present invention, the distances between the locations of introduction of solutions (α1) and (α2) or (α3) or (α4) are added are equal or larger than six times the hydraulic diameter of the tip of the inlet of solution (α1).

The hydraulic diameter is defined as the four-fold of the cross-sectional area of the inlet tip di-vided by the wetted parameter of the inlet tip.

In one embodiment of the present invention, the distance between the outlet of the tank reactor and the tip of the inlet of solution (α2) or (α3) or (α4) is at most fifteen times the outer hydraulic diameter of the tip of the respective inlet, preferably at most ten times and more preferably at most six times and even more preferably at four times, while the distance between the outlet of the reactor and the tip of the inlet of solution (α1) is at least fifteen times the outer hydraulic diameter of the tip of the inlet of solution (α1), for example 100 to 200 times. Preferably, the tip of the inlet of solution (α2) or (α3) or (α4) is at least twice the outer hydraulic diameter of the tip of the respective inlet.

There are various ways to add solution (β) to the tank reactor.

In one embodiment, the distance between the tip of the inlet of solution (β) and each of the inlets of solution (α1) and (α2) and (α3) and (α4) is at least ten times the largest hydraulic diameter of the inlets of solution (α1) and (α2) and (α3) and (α4). In embodiments wherein tips that are compared have different hydraulic diameters, the data refer to the larger hydraulic diameter.

In another embodiment, the distance of the locations of introduction of solution (α1) and (β) is equal or less than 12 times the hydraulic diameter of the tip of the inlet pipe of the alkali metal hydroxide. In a preferred embodiment, solutions (α1) and (β) are introduced through a coaxial mixer.

In one embodiment of the present invention, step (b) is performed at a temperature in the range from 10 to 85° C., preferably at temperatures in the range from 20 to 60° C.

In one embodiment of the present invention, the pH value of the liquid phase is in the range of from 10.0 to 14.0. In the context of the inventive process, the pH value refers to the pH value of the respective solution or slurry at 23° C.

In one embodiment of the present invention, step (b) is performed at constant pressure, for example at ambient pressure. In other embodiments, step (b) is performed at elevated pressure, for example up to 50 bar.

In one embodiment of the present invention, step (b) is performed in the steady state, and simultaneously with addition of solutions (α1) and (β) and at least one of solutions (α2) or (α3) or (α4), and, if applicable, any of solutions (γ) or (δ), resulting slurry is removed from the reactor, for example through an overflow.

In another embodiment of the present invention, step (b) is performed in a dynamic state, and the velocity of addition of solutions (α1) and (β) and of at least one of solutions (α2) or (α3) or (α4) is altered during step (b).

In one embodiment of the present invention, in the course of step (b), stirring is performed with a speed providing a medium dissipation rate in the range of from 0.1 W/kg to 10 W/kg, preferably from 0.5 W/kg to 7 W/kg. For example, in case of a stirred tank reactor with a volume of 3.2 liters, typical stirring speeds range from 400 rpm to 1000 rpm (revolutions per minute).

In one embodiment of the present invention, the average residence time is in the range of from 30 minutes to 12 hours, preferably in the range from 1 to 8 hours, more preferred in the range of 2 to 6 hours.

In one embodiment of the present invention, extra mother liquor is removed from the continuous reactor. The mother liquor contains water and alkali metal salts. The counter ion is then the counter ion of nickel and of the metals other than nickel. If for example, nickel sulfate is used as water-soluble salt of nickel in solution (α1) and sodium hydroxide or sodium carbonate in solution (β), then the mother liquor contains sodium sulfate. The mother liquor may further contain ammonia and/or an alkali metal salt of a carboxylic acid.

By performing step (b), solid particles of a hydroxide or carbonate or oxyhydroxide are created, said solid particles being slurried. Thus, a slurry is obtained.

In step (c), the particles from step (b) are separated from the liquid phase by a solid-liquid separation method, preferably by filtration or in a centrifuge. The liquid phase may also be termed mother liquor. Filtration may be performed, e.g., on a belt filter or in a filter press.

In order to remove mother liquor, it is preferred to wash the filter cake, for example with water or with alkali metal hydroxide or alkali metal carbonate solution.

Filtration may be supported by suction or by pressure.

Step (c) may be performed at any temperature at which water is in the liquid state, for example 5 to 95° C., preferred is 20 to 60° C.

By performing step (c), a solid material is obtained which is a particulate (oxy)hydroxide or carbonate or oxide of TM. Said material usual has a high water content, for example 1 to 30% by weight, and may be dried, e.g. at air, at a temperature in the range of from 80 to 150° C., or at reduced pressure (“in vacuo”), to a moisture content in the range of from 100 to 5,000 ppm, ppm being ppm by weight. The water content may be determined by drying in vacuo at a temperature of 100° C. until the weight is remaining unchanged. The moisture content may be determined by Karl-Fischer titration.

Subsequently to step (c) or to drying, said particulate (oxy)hydroxide or carbonate or oxide of TM may be subjected to a step (d). Step (d) includes a thermal treatment of the solid from step (c) in a rotary kiln or in a flash calciner.

In one embodiment of step (d), the wet solid material is introduced into the rotary kiln by a chute or a vibrating chute, by a spiral conveyor or a screw conveyor, preferably by a screw conveyor with a single screw or multiple screws.

The wet particulate solid is then moved through the rotary kiln. Upon moving wet particulate solid the moisture content decreases. Preferably, at the end of the inventive process the residual moisture content is in the range of from 50 ppm to 1.5% by weight, preferably 100 to 300 ppm by weight. The ppm are parts per million and refer to the weight. The residual moisture content may be determined by Karl-Fischer titration.

In one embodiment of the present invention, the retort length of the rotary kiln is from one to 50 m, preferably from 5 to 25 meter.

In one embodiment of the present invention, the retort diameter of the rotary kiln is in the range of from 0.2 to 4 meter, preferably 1 to 2 meter.

In one embodiment of the present invention, the ratio retort length to retort diameter is in the range of from 5 to 50, preferably 10 to 25.

In one embodiment of the present invention, the rotary kiln is exactly horizontal. In another embodiment, the rotary kiln is tilted, for example with a tilt angle in the rage of from 0.2 to 7°, and the movement of the particulate solid through the rotary kiln is supported by gravitational force.

In one embodiment of the present invention, the rotary kiln is operated with 0.01 to 20 revolutions per minute, preferred are 0.5 to 5 revolutions per minute, and, in each case, continuously or in intervals. When operation in an interval mode is desired it is possible, for example, to stop the rotation after one to 5 revolutions for one to 60 minutes, and then to again perform 1 to 5 revolutions and again stop for 1 to 60 minutes, and so forth.

Said particulate material is moved through a rotary kiln with a flow of gas.

In one embodiment of step (d), the flow of gas has an inlet temperature in the range of from zero to 1400° C., preferred are 20 or 200 to 1000° C. In embodiments wherein the gas inlet temperature is 100° C. or higher a preheating system is required. In embodiments wherein a preheating system is not desired the inlet temperature corresponds to ambient temperature.

In a preferred embodiment, in a first temperature zone the temperature of said particulate material is in the range of from 80 to 130° C. and in a second temperature zone, the temperature is in the range of from 200 to 500° C., preferably 200 to 450° C., more preferably 220 to 300° C. Said temperature may be determined with a sensor. At temperatures above 200° C., carbon dioxide is cleaved off from carbonates, and/or hydroxyl groups are removed as water, depending on the chemical nature of the respective solid material. The removal of carbon dioxide and/or of water may be complete or partial, partial being preferred. A preferred range of partial removal of carbon dioxide is 60 to 99%, a preferred range of partial removal of water is 68 to 99%.

A further aspect of the present invention is directed towards particulate (oxy)hydroxides, hereinafter also being referred to as inventive (oxy)hydroxides or inventive precursors. Inventive (oxy)hydroxides are particulate (oxy)hydroxides of TM with a brucite structure wherein TM contains nickel and at least one metal selected from cobalt, manganese and aluminum. Preferably, TM contains nickel and at least two of cobalt, manganese and aluminum.

Inventive precursors have a core-shell structure, in which at least one of cobalt, manganese and aluminum is enriched in the shell compared to the core, for example by at least 5 mol-%, referring to the sum of nickel, cobalt, manganese and aluminum, but preferably by no more than 30 mol-%.

Inventive precursors have mainly a brucite structure that displays C19 stacking faults leading to local CdCl₂ structural areas that are induced by molecules or ions intercalated into the crystal lattice selected from carbonate, sulfate and counterions of organic acids selected from selected from tartaric acid, citric acid and glycine, with a transition probability for an intercalation layer in the range of from 2 to 10%, preferably 4 to 8%. The stacking faults including the transition probability may be detected and quantified by X-ray diffraction.

In addition, inventive (oxy)hydroxide has a particle diameter distribution with a span in the range of from 0.9 to 2.0. The diameters (D10), (D50) and (D90) may be determined by dynamic light scattering.

In one embodiment of the present invention, TM corresponds to general formula (I)

(NiₐCo_{b}Mn_{c})_{1-d}M_{d} (I)
a being in the range of from 0.5 to 0.95, preferably from 0.8 to 0.92,
b being zero or in the range of from 0.025 to 0.5, preferably from 0.025 to 0.15,
c being in the range of from zero to 0.2, preferably from zero to 0.15, and
d being in the range of from zero to 0.1, preferably from zero to 0.05,
M is selected from Mg, Al, Ti, Zr, Mo, W, and Nb,
a+b+c=1, and b+c>zero or M includes Al and d>zero.

TM may contain traces of further metal ions, for example traces of ubiquitous metals such as sodium, iron, calcium or zinc, as impurities but such traces will not be taken into account in the description of the present invention. Traces in this context will mean amounts of 0.05 mol-% or less, referring to the total metal content of TM.

Inventive precursors are particulate (oxy)hydroxide of TM. In the context of the present invention, “(oxy)hydroxides” refer to hydroxides and do not only include stoichiometrically pure hydroxides but especially also compounds which, as well as transition metal cations and hydroxide ions, also have anions other than hydroxide ions, for example oxide ions and carbonate ions, or anions stemming from the transition metal starting material, for example acetate or nitrate and especially sulfate. Oxide ions may stem from a partial oxidation, for example oxygen uptake during drying. Carbonate may stem from the use of technical grade alkali metal hydroxide.

Inventive precursors are particulate materials. In one embodiment of the present invention, inventive precursors have an average particle diameter D50 in the range of from 3 to 20 μm, preferably from 4 to 16 μm. The average particle diameter may be determined, e. g., by light scattering or LASER diffraction or electroacoustic spectroscopy. The particles are composed of primary particles, in particular they are agglomerates of primary particles, and the above particle diameter refers to the secondary particle diameter.

The span of the particle diameter distribution of the precursor is in the range of from 0.9 to 2.0. The span is defined as [(D90)−(D10)]/(D50), with the values of (D90), (D50) and (D10) being determined by dynamic light scattering. Preferably, the particle diameter distribution is mono-modal.

Inventive precursors may have an irregular shape but in a preferred embodiment, they have a regular shape, for example spheroidal or even spherical. The aspect ratio may be in the range of from 1 and 10, preferably from 1 to 3 and even more preferably from 1 to 1.5. The aspect ratio is defined as the ratio of width to length or specifically the particle diameter in the longest dimension versus the particle diameter in the shortest dimension. Perfectly spherical particles have an aspect ratio of 1.

Inventive (oxy)hydroxides are excellently suited for making cathode active materials for lithium ion batteries, for example directly by mixing with a source of lithium such as lithium hydroxide or lithium carbonate and then thermal treatment, or by a two-step process of first heating it in the absence of a source of lithium to 300 to 550° C., then mixing it with a source of lithium at ambient temperature and thermally treating the resultant mixture. Such thermal treatment may be performed at 600 to 1000° C.

In one embodiment of the present invention, TM corresponds to general formula (I)

(NiₐCo_{b}Mn_{c})_{1-d}M_{d} (I)

with
a being in the range of from 0.5 to 0.95,
b being zero or in the range of from 0.025 to 0.5,
c being in the range of from zero to 0.2, and
d being in the range of from zero to 0.1,
M is selected from Mg, Al, Ti, Zr, Mo, W, Nb, and Ta,
and a+b+c=1, and b+c>zero or M includes Al and d>zero.

The portion of radially oriented primary particles may be determined, e.g., by SEM (Scanning Electron Microscopy) of a cross-section of at least 5 secondary particles.

“Essentially radially oriented” does not require a perfect radial orientation but includes that in an SEM analysis, a deviation to a perfectly radial orientation is at most 11 degrees, preferably at most 5 degrees.

In one embodiment of the present invention, inventive precursors have a specific surface according to BET (hereinafter also “BET surface”) in the range of from 2 to 70 m²/g, preferably from 4 to 50 m²/g. The BET surface may be determined by nitrogen adsorption after outgassing of the sample at 120° C. for 30 minutes or more and beyond this accordance with DIN ISO 9277:2010.

Inventive precursors may be manufactured according to the inventive process.

Inventive precursors are excellently suited for making cathode active materials with excellent cycling behavior, directly or after preliminary dehydration. Such cathode active materials may be made by mixing inventive precursor with a source of lithium, e.g., Li₂O or LiOH or Li₂CO₃, each water-free or as hydrates, and calcination, for example at a temperature in the range of from 600 to 1000° C. A further aspect of the present invention is thus the use of inventive precursors for the manufacture of cathode active materials for lithium ion batteries, and another aspect of the present invention is a process for the manufacture of cathode active material for lithium ion batteries—hereinafter also referred to as inventive calcination—wherein said process comprises the steps of mixing an inventive particulate transition metal (oxy)hydroxides with a source of lithium and thermally treating said mixture at a temperature in the range of from 600 to 1000° C. Preferably, the ratio of inventive precursor and source of lithium in such process is selected that the molar ratio of Li and TM is in the range of from 0.95:1 to 1.2:1, more preferably 0.98 to 1.05.

Of particular advantage are precursors after performance of step (d), hereinafter also referred to as inventive oxides. A further aspect of the present invention is directed to particulate oxides of TM wherein TM contains nickel and at least one metal selected from cobalt, manganese and aluminum and wherein such particulate oxide has a core-shell structure, in which at least one of cobalt, manganese and aluminum is enriched in the shell, has a particle diameter distribution with a span in the range of from 0.9 to 2.0, a specific surface (BET) in the range of from 20 to 100 m²/g and an average crystallite size in the range of from 100 to 300 Å.

TM is defined as above as well as properties like average particle diameter D50) and span. Inventive oxides have a rock salt structure instead of a brucite structure

The specific surface (BET) is in the range of from 20 to 200 m²/g, preferably from 40 to 120 m²/g, determined through nitrogen adsorption after outgassing of the sample at 200° C. for 40 minutes and beyond this accordance with DIN ISO 9277:2010.

The invention is further illustrated by a working example and a drawing, see FIG. 1.

### BRIEF DESCRIPTION OF THE DRAWING

A: reaction vessel
B: stirrer blades
C: feed inlet for aqueous solution (α1.1)
D: ammonia feed inlet
E: sodium hydroxide feed inlet, solution (β.1)
F: aqueous cobalt sulfate solution feed inlet, solution (α2.1)
G: baffle

### WORKING EXAMPLE

Percentages refer to % by weight unless expressly noted otherwise. All pH values were determined at 23° C.

The co-precipitation reactions were performed in a 250-ml stirred tank reactor (Reactor 1), see FIG. 1, equipped with an overflow system and four dosing inlets as well as a pH value regulation circuit (not shown in the drawing). The four dosing inlets were arranged in a circuit around the stirrer. Feed inlet C had the closest proximity to the overflow. Both inlet pipes C and F were arranged in a distance of 100 times the hydraulic diameter measured from the inlet pipes.

For determination of the element distribution over the particle diameter, inventive precursor was embedded in Epofix resin (Struers, Copenhagen, Denmark). Ultra-thin samples (˜100 nm) for Transmission Electron Microscopy (TEM) were prepared by ultramicrotomy and transferred to TEM sample carrier grids. The samples were imaged by TEM using Tecnai Osiris and Themis Z3.1 machines (Thermo-Fisher, Waltham, USA) operated at 200/300 keV under HAADF-STEM conditions. Chemical composition maps were acquired by energy-dispersive x-ray spectroscopy (EDXS) using a SuperX G2 detector. Images and elemental maps were evaluated using the Velox (Thermo-Fisher) as well as the Esprit (Bruker, Billerica, USA) software packages.

Step (a.1): The following aqueous solutions were provided by dissolving the respective compound in water:
Solution (α1.1): NiSO₄, 1.65 ml/kg in water
Solution (α1.2): CoSO₄, 1.65 ml/kg in water
Solution (β.1): 25% by weight NaOH in water
Solution (γ.1): 25% by weight NH 3 in water

Step (b.1):

Reactor 1 was charged with 6 mL of solution (γ.1). Then, the pH value of the solution was adjusted to 12.10 (if measured at 23° C.) using solution (β.1). Then, the temperature of the Reactor 1 was set to 55° C. The stirrer was constantly operated at 700 rpm. Simultaneously, solution (α1.1) was introduced through inlet C and solution containing (α2.1) through inlet F, solution (β.1) through inlet E and solution (γ.1) through inlet D. The molar ratio between nickel and cobalt was adjusted to 55:45.

The molar ratio between ammonia and the sum of nickel and cobalt was adjusted to 0.25. The sum of volume flows was set to adjust the mean residence time to 2.5 hours. The flow rate of (β.1) was adjusted by a pH regulation circuit to keep the pH value in the vessel at a constant value of 12.10. Reactor 1 was operated continuously keeping the liquid level in the vessel constant. A mixed hydroxide of Ni and Co, TM-OH.1, was collected via overflow from the vessel. The resulting product slurry contained about 120 g/l mixed hydroxide TM-OH.1 with an average particle size (D50) of 8.14 μm and a span of 1.26.

Due to the addition of the Co closer to the overflow, Co is enriched in the outer part of the particles of TM-OH.1 but not in the shell.

Step (c.1): TM-OH.1 particles were collected, filtered, washed with deionized water, dried and sieved using a mesh size of 30 μm. The residual Sulphur content of the dried TM-OH.1 was 0.21 wt %, and TM-OH.1 exhibited a specific surface (BET) of 4.41 m²/g. Further, the particles of TM-OH.1 exhibited a Ni-rich core, followed by a Co enriched transition shell and again a Ni-rich terminating shell which was enriched by approximately 5-7 mol % more Ni compared Nickel content in the Co enriched transition shell as verified by TEM-EDX (see FIGS. 2 and 3). By application of stacking fault modeling on measured XRD diffraction patterns the average crystallite size was determined to 177 Å. The transition probability p_{car}, for the occurrence of a C19 stacking fault by an intercalation layer between the brucite-type layers consisting of sulphate ions was determined to p_{car}=6.2% based on the corresponding X-ray diffraction pattern in FIG. 4. The stacking faults lead to local CdCl₂ structural areas.

For conversion to a dehydrated precursor, TM-OH.1 was subjected to thermal treatment at 500° C. in a Linn oven in the absence of any lithium source to yield mixed oxide particles, TMO.1. The specific surface (BET) of TMO.1 was 46.19 m²/g. TMO.1 exhibited an average crystallite size of 152 Å which was extracted from the XRD pattern in FIG. 5. The previously mentioned concentration gradient within the secondary particles of TMO.1 was retained despite heat treatment. TMO.1 exhibited a Ni-rich core, followed by a Co-rich transition shell and again a Ni-rich shell as verified by TEM-EDX (see FIGS. 6 and 7).

1. A process for making a particulate (oxy)hydroxide or carbonate or oxide of TM, wherein TM comprises nickel and at least one metal selected from the group consisting of cobalt and manganese and aluminum, the process comprising:
(a) providing an aqueous solution (α1) containing a water-soluble salt of Ni and an aqueous solution (α2) containing a water-soluble salt of Co or an aqueous solution (α3) containing a water-soluble salt of Mn or an aqueous solution (α4) containing a water-soluble compound of Al, and an aqueous solution (β) containing an alkali metal hydroxide or carbonate and, optionally, an aqueous solution (γ) containing ammonia or an organic acid or its alkali metal salt,
(b) combining solution (α1) and solution (β) and at least one of solutions (α2) or (α3) or (α4), and, if applicable, solution (γ), in a continuous reactor, thereby creating solid particles of a hydroxide or carbonate of TM, wherein such solutions are introduced into said continuous reactor in different locations, and
(c) separating the particles from step (b) from the liquid phase by a solid-liquid separation method,
and wherein the distances between the locations of introduction of solutions (α1) and (α2) or (α3) or (α4) are equal or larger than six times the hydraulic diameter of the tip of the inlet of solution (α1).

2. The process according to claim 1 wherein step (b) is performed in a continuous stirred tank reactor.

3. The process according to claim 1 wherein the particulate mixed transition metal precursor is selected from the group consisting of (oxy)hydroxides, carbonates, and oxides of TM, wherein TM is a combination of metals according to general formula (I)
(NiₐCo_{b}Mn_{c})_{1-d}M_{d} (I)
wherein
a is in the range of from 0.5 to 0.95,
b is zero or in the range of from 0.025 to 0.5,
c is in the range of from zero to 0.2, and
d is in the range of from zero to 0.1,
M is selected from the group consisting of Mg, Al, Ti, Zr, Mo, W, and Nb, and
a+b+c=1, and b+c>zero or M includes Al and d>zero.

4. The process according to claim 1 wherein the distance between the outlet of the tank reactor and the tip of the inlet of solution (α2) or (α3) or (α4) is at most fifteen times the hydraulic diameter of the tip of the respective inlet while the distance between the outlet of the reactor and the tip of the inlet of solution (α1) is at least fifteen times the hydraulic diameter of the tip of the inlet of solution (α1).

5. The process according to claim 1 wherein in step (b), the velocities of addition of solutions (α1) and (α2) or (α3) or (α4) are independently from each other varied in the range from 0.1 to 10 m/s.

6. The process according to claim 1 wherein in step (b) a water-soluble compound of a metal M selected from the group consisting of Mg, Ti, Zr, Mo, W, and Nb, is added as an aqueous solution (δ).

7. The process according to claim 1 wherein the organic acid in solution (γ) is selected from the group consisting of tartaric acid, citric acid, and glycine.

8. The process according to claim 1 wherein said process includes the additional step (d) of thermally treating the solid residue from step (c) in a rotary kiln or a flash calciner.

9. A particulate (oxy)hydroxide of TM comprising a brucite structure, wherein TM contains nickel and at least one metal selected from the group consisting of cobalt, manganese and aluminum, and wherein such particulate (oxy)hydroxide has a core-shell structure, in which at least one component selected from the group consisting of cobalt, manganese, and aluminum is enriched in the shell, and wherein said brucite structure display C19 stacking faults leading to local CdCl₂ structural areas that are induced by molecules or ions intercalated into the crystal lattice selected from the group consisting of water, carbonate, sulfate, and counterions of organic acids selected from the group consisting of tartaric acid, citric acid, and glycine, with a transition probability for an intercalation layer in the range of from 2 to 10%, and wherein said (oxy)hydroxide has a particle diameter distribution with a span defined as [(D90)−(D10)]/(D50) in the range of from 0.9 to 2.0.

10. The particulate (oxy)hydroxide according to claim 9 wherein TM is a combination of metals according to general formula (I)
(NiₐCo_{b}Mn_{c})_{1-d}M_{d} (I)
wherein
a is in the range of from 0.5 to 0.95,
b is zero or in the range of from 0.025 to 0.5,
c is in the range of from zero to 0.2, and
d is in the range of from zero to 0.1,
M is selected from the group consisting of Mg, Al, Ti, Zr, Mo, W, and Nb,
and a+b+c=1, and b+c>zero or M includes Al and d>zero.

11. The particulate (oxy)hydroxide according to claim 9, wherein the at least one component selected from the group consisting of cobalt, manganese, and aluminum is enriched in the shell of the secondary particle by at least 5 mol-%, referring to the sum of nickel, cobalt, manganese and aluminum and compared to the core.

12. The particulate (oxy)hydroxide according to claim 9 wherein at least 60 vol.-% of the secondary particles consist of primary particles that are essentially radially oriented, wherein primary particles that are essentially radially oriented are selected from the group consisting of radially oriented primary particles and primary particles that show a deviation to a perfectly radial orientation of at most 11 degrees in an SEM analysis.

13. The particulate (oxy)hydroxide according to claim 9 having a moisture content in the range of from 100 to 5,000 ppm, determined by Karl-Fischer titration.

14. A particulate oxide of TM wherein TM contains nickel and at least one metal selected from the group consisting of cobalt, manganese, and aluminum and wherein such particulate oxide has a core-shell structure, in which at least one component selected from the group consisting of cobalt, manganese, and aluminum is enriched in the shell, has a particle diameter distribution with a span defined as [(D90)−(D10)]/(D50) in the range of from 0.9 to 2.0, a specific surface (BET) in the range of from 20 to 200 m²/g and an average crystallite size in the range of from 100 to 300 Å.
